(19) United States
(12) Patent Application Publication
(10) Pub. No.: US 2019/0358589 A1
(43) Pub. Date: Nov. 28, 2019

(54) ION CONDUCTIVE SPACER, PREPARING PROCESS THEREOF AND ELECTRODIALYSIS REVERSAL STACK

(71) Applicant: BL TECHNOLOGIES, INC., Minnetonka, MN (US)

(72) Inventors: Wei LU, Shanghai (CN); Hongchen DONG, New York, NY (US); Jiyang XIA, Shanghai (CN); Yongchang ZHENG, Westborough, MA (US); Su LU, Shanghai (CN); John H. BARBER, Guelph (CA); Russell James MACDONALD, Westborough, MA (US)

(73) Assignee: BL Technologies, Inc., Minnetonka, MN (US)

(21) Appl. No.: 16/476,096

(22) PCT Filed: Jan. 9, 2018
(86) PCT No.: PCT/US2018/013026

§ 371 Date: Jul. 4, 2019

(30) Foreign Application Priority Data
Jan. 13, 2017 (CN) 201710026200.8

(51) Int. Cl. B01D 61/48; H01M 8/1081; C02F 1/469; B01J 47/12

(52) U.S. Cl. CPC B01D 61/48; H01M 8/1081; B01D 2313/14; B01J 47/12; C02F 1/4693

(57) ABSTRACT

An ion conductive spacer for use in an electrodialysis reversal stack is disclosed, which includes a plastic netting and a polymeric coating coated on the plastic netting and containing charged groups. The morphology of the polymeric coating has interconnected ionic clusters which allow continuous and macroscopic ion transportation throughout a surface of the plastic netting. An electrodialysis reversal stack using the above ion conductive spacer and a process for preparing the above ion conductive spacer are also disclosed.

### BACKGROUND

This disclosure relates generally to the field of membrane spacers, and more particularly to an ion conductive spacer for use in an electrodialysis reversal (EDR) stack, processes for preparing the ion conductive spacer and an electrodialysis reversal stack using the ion conductive spacer.

An ion conductive spacer is a functionalized membrane spacer which is commonly used in a liquid separation device of an electrochemical desalination product such as electrodialysis, electrodialysis reversal and reverse osmosis. Usually, specific materials need to be attached onto the membrane spacer by coating. The ion conductive spacer may help reducing resistance, and therefore improving salt removal rate. However, the ion conductive spacer will encounter harsh environment like acidic/caustic/oxidative chemicals and physical cleaning during 5-10 years service life. Therefore, the ion conductive spacer will require high performance coating materials which don't degrade or spall apart from a plastic netting of the spacer. Usually, the coating materials need to have specific function like improvement of conductivity and resistance reduction. Thus, the coating materials may play an important role in performance improvement of the ion conductive spacer.

Furthermore, the substrate of the ion conductive spacer is usually made of plastic netting such as polypropylene (PP) or polyethylene (PE). Since such type of plastic netting is non-polar and non-porous with a smooth surface and large open windows (usually 2×2 mm size), it is a big challenge to apply stable and uniform coating onto the plastic netting without blockage of windows. Meanwhile, the plastic netting tends to deformed during coating drying process at high temperature. Thus, the coating process of plastic netting is challenging and critical for manufacturing ion conductive spacers.

### BRIEF DESCRIPTION

In one embodiment, the present disclosure provides an ion conductive spacer for use in an electrodialysis reversal stack. The ion conductive spacer comprises a plastic netting and a polymeric coating coated on the plastic netting and containing charged groups. The morphology of the polymeric coating has interconnected ionic clusters which allow continuous and macroscopic ion transportation throughout a surface of the plastic netting.

In another embodiment, the present disclosure provides an electrodialysis reversal stack. The electrodialysis reversal stack comprises a first electrode and a second electrode, a plurality of ion conductive spacers as claimed above and located between the first and the second electrodes, and at least one anionic exchange membrane and at least one cationic exchange membrane. The at least one anionic exchange membrane and the at least one cationic exchange membrane are inserted alternately between every adjacent two ion conductive spacers.

In still another embodiment, the present disclosure provides a process for preparing an ion conductive spacer in an electrodialysis reversal stack. The process comprises: dissolving a polymer containing charged groups in a solvent to prepare a polymer solution, coating the polymer solution onto a plastic netting to form a coated netting; and drying the coated netting so as to remove the solvent and form a polymer coating on the plastic netting. The morphology of the resulting polymer coating has interconnected ionic clusters which allow continuous and macroscopic ion transportation throughout a surface of the plastic netting.

In yet another embodiment, the present disclosure provides a process for preparing an ion conductive spacer. The process comprises: dissolving a polymer containing charged groups in a solvent to prepare a polymer solution, coating the polymer solution onto a plastic netting to form a coated netting; and drying the coated netting by microwave so as to remove the solvent.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic structure diagram of an electrodialysis reversal stack;

FIG. 2 is a schematic diagram of a portion of an uncoated plastic netting;

FIG. 3 is a cross-sectional view of a strand of the uncoated plastic netting of FIG. 2;

FIG. 4 is a schematic diagram of a portion of a coated plastic netting in accordance with an embodiment of the present disclosure;

FIG. 5 is a cross-sectional view of a strand of the coated plastic netting of FIG. 4;

FIG. 6 is a desalination process of an EDR stack;

FIG. 7 is a comparison diagram of current density of EDR stacks using a PVA+IX coated PP spacer and a PP spacer;

FIG. 8 is a diagram of resistance reduction of Kraton coated PP spacers having different ion exchange capacity;

FIG. 9 is a comparison diagram of current density of EDR stacks using a Kraton coated PP spacer and the PP spacer;

FIG. 10 is a comparison diagram of salt removal rate of the EDR stacks using the Kraton coated PP spacer and the PP spacer;

FIG. 11 is a comparison diagram of current density of EDR stacks using a Nafion coated PP spacer and the PP spacer;

FIG. 12 is a comparison diagram of salt removal rate of the EDR stacks using the Nafion coated PP spacer and the PP spacer;

FIG. 13 is a diagram of resistance reduction of SPSU coated PP spacers having different sulfonation degrees;

FIG. 14 is a comparison diagram of current density of EDR stacks using SPSU50 coated PP spacer and the PP spacer;

FIG. 15 is a comparison diagram of salt removal rate of the EDR stacks using SPSU50 coated PP spacer and the PP spacer;

FIG. 16 is a schematic diagram of desalination efficiency of an EDR three stages system without conductive spacer;

FIG. 17 is a schematic diagram of desalination efficiency of an EDR two stages system with ion conductive spacer in accordance with an embodiment of the present disclosure;

FIG. 18 is a flow chart of an exemplary process for preparing an ion conductive spacer for use in an EDR stack in accordance with a first embodiment of the present disclosure;

FIG. 19 is a flow chart of an exemplary process for preparing an ion conductive spacer for use in an EDR stack in accordance with a second embodiment of the present disclosure; and

FIG. 20 is a proof of microwave being used for solvent removal.

### DETAILED DESCRIPTION

Embodiments of the present disclosure will be described herein below with reference to the accompanying drawings. In the following description, well-known functions or constructions are not described in detail to avoid obscuring the disclosure in unnecessary detail.

Unless defined otherwise, technical and scientific terms used herein have the same meaning as is commonly understood by one of ordinary skill in the art to which this disclosure belongs. The terms “first”, “second”, “third” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either or all of the listed items. The use of “including,” “comprising” or “having” and variations thereof herein are meant to encompass the items listed thereafter and equivalents thereof as well as additional items.

Approximating language, as used herein throughout the specification and claims, may be applied to modify any quantitative representation that could permissibly vary without resulting in a change in the basic function to which it is related. Accordingly, a value modified by a term or terms, such as “about”, “approximately” and “substantially”, are not to be limited to the precise value specified. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

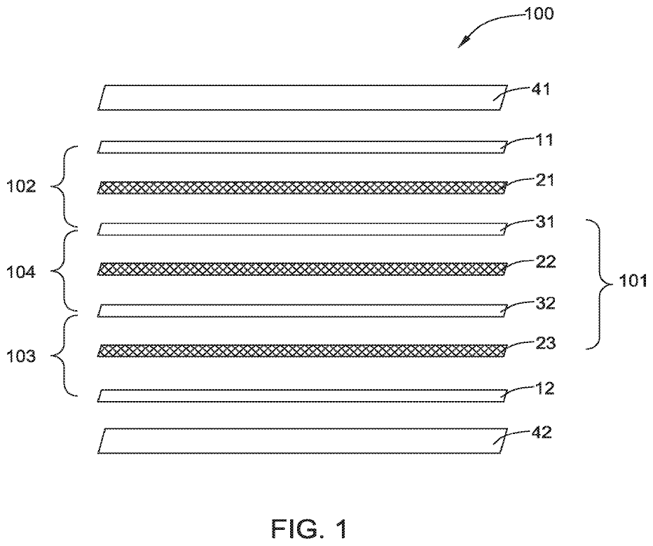

FIG. 1 illustrates a schematic structure diagram of an electrodialysis reversal (EDR) stack 100. As shown in FIG. 1, the EDR stack 100 may include a first electrode 11 and a second electrode 12, a plurality of ion conductive spacers located between the first and the second electrodes 11 and 12, and at least one anionic exchange membrane 31 and at least one cationic exchange membrane 32. The at least one anionic exchange membrane 31 and the at least one cationic exchange membrane 32 are inserted alternately between every adjacent two ion conductive spacers. For example, the number of ion conductive spacer is shown in FIG. 1 to be three, that is, the ion conductive spacers 21, 22 and 23. The anionic exchange membrane 31 is inserted between the ion conductive spacers 21 and 22. The cationic exchange membrane 32 is inserted between the ion conductive spacers 22 and 23. The anionic exchange membrane 31, the ion conductive spacer 22, the cationic exchange membrane 32, and the ion conductive spacer 23 may construct one cell pair 101 as shown in FIG. 1. However, as a matter of fact, the EDR stack 100 may include a plurality of cell pairs 101 as required.

A first electrode chamber 102 is formed between the first electrode 11 and the anionic exchange membrane 31. A second electrode chamber 103 is formed between the second electrode 12 and the cationic exchange membrane 32. One membrane chamber 104 is formed between every one anionic exchange membrane 31 and every one cationic exchange membrane 32. The EDR stack 100 may include a plurality of membrane chambers 104, and the plurality of membrane chambers 104 includes dilute chambers and concentrate chambers.

The EDR stack 100 may further include a first plastic endplate 41 for covering the first electrode 11 and a second plastic endplate 42 for covering the second electrode 12.

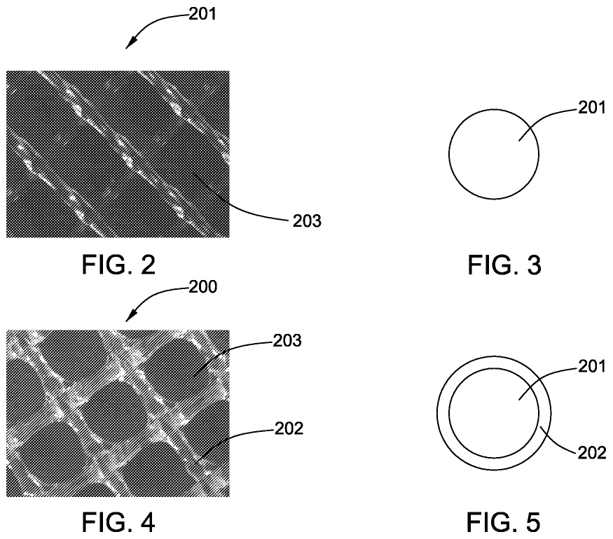

The present disclosure may provide an ion conductive spacer 200 for use in the electrodialysis reversal stack 100. FIGS. 2 and 3 illustrate an uncoated plastic netting 201. FIGS. 3 and 4 illustrate a coated plastic netting. As shown in FIGS. 2-5, the ion conductive spacer 200 may include a plastic netting 201, and a polymeric coating 202 (also known as a coating material) coated on the plastic netting 201. The plastic netting 201 may have a plurality of windows 203 therein. The plastic netting 201 may be made of polypropylene (PP) or polyethylene (PE).

In the ion conductive spacer 200 of the present disclosure, the polymeric coating 202 contains charged groups, and the morphology of the polymeric coating 202 has interconnected ionic clusters which allow continuous and macroscopic ion transportation throughout a surface of the plastic netting 201.

Such the ion conductive spacer 200 of the present disclosure uses the polymeric coating 202 having interconnected ionic clusters, and may thus have better ionic conductivity and higher resistance decrease percentage. The salt removal rate of the EDR stack 100 using such the ion conductive spacer 200 of the present disclosure may get improved by at least 20% in comparison to the uncoated spacer, i.e. the plastic netting 201.

The following examples are intended to further demonstrate embodiments of the present disclosure, so that aspects of the present disclosure may be more fully understood. But they are not intended to limit the present disclosure in any way. On the contrary, they are intended to cover all alternatives, modifications and equivalents as may be included within the scope of the invention as defined by the appended claims.

### Test 1: Testing of Spacer

The coated spacer (i.e. ion conductive spacer) and the uncoated spacer (i.e. the uncoated plastic netting 201) were respectively soaked in 0.01 mol/L sodium chloride (NaCl) solution. The plastic netting 201 used was polypropylene (PP) netting. The ohmic resistances of the coated spacer and the plastic netting 201 were measured by using an electrochemical AC (Alternating Current) impedance method. In the AC impedance method, AC amplitude used was 10 mV and frequency sweep used was from 1 Hz to 1 MHz.

Resistance reduction is defined by reduction of the resistance of the coated spacer relative to the resistance of the uncoated plastic netting 201. The resistance reduction percentage of the coated spacer is versus the uncoated plastic netting 201 in 0.01 mol/L sodium chloride (NaCl) solution.

### Test 2: Testing of EDR Stack

In the test of the EDR stack, the EDR stack with the uncoated spacer (hereinafter referred to as PP spacer) and the EDR stack with the coated spacer (hereinafter referred to as coated PP spacer) were respectively tested.

In this test, the number of cell pairs 101 included in the EDR stack 100 was 5 or 10. The anionic exchange membrane 31 used in the EDR stack 100 was a GE's (General Electric Company) commercial membrane whose model is AR204, and the cationic exchange membrane 32 used in the EDR stack 100 was a GE's commercial membrane whose model is CR67.

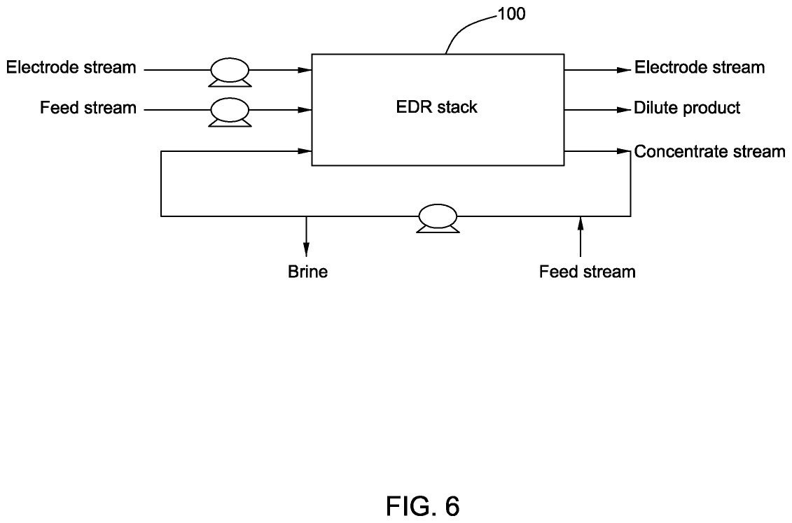

FIG. 6 illustrates a desalination process of the EDR stack 100. As shown in FIG. 6 in combination with FIG. 1, during the desalination process of the EDR stack 100, 2500/cm Na₂SO₄ solution or 0.01 mol/L NaCl solution as a feed stream went into the membrane chamber 104 of the EDR stack 100, and 0.01 mol/L Na₂SO₄ solution as an electrode stream went into the first and the second electrode chamber 102 and 103 of the EDR stack 100 by a single pass in a continuous mode. The velocities of the feed stream and the electrode stream were 10 cm/s. In addition, a concentrate stream which flowed out of the EDR stack 100 flowed back into the EDR stack 100 to form a loop, the brine was blown down and 250 μS/cm Na₂SO₄ solution or 0.01 mol/L NaCl solution (i.e. fresh feed stream) was continuously added into the loop to ensure the water recovery is 85% and maintain constant concentration. A voltage was imposed to the EDR stack 100 and EDR stack's current was then measured. The dilute product in the dilute chamber of the EDR stack 100 was collected and conductivity of the dilute product was then measured. The salt removal rate of the EDR stack 100 was obtained based on the conductivity of the feed stream and the conductivity of the dilute product.

Testing data in the following examples was obtained by performing Test 1 or Test 2 above.

### COMPARATIVE EXAMPLE

### Heterogeneous Conductive Coating

In this comparative example, the polymeric coating used a heterogeneous conductive coating which has no interconnected ionic clusters. The heterogeneous conductive coating was made by a blend of poly(vinyl alcohol) (PVA) and ground ion exchange (IX) resin powder (a mixture of Amberlite™ FPC14 Na (which is a strong acid cation exchange resin, supplied in the Na-form) and Amberlite™ FPA42 Cl (which is a strong base (Type I) anion exchange resin, supplied in the Cl-form) from Dow Chemical Company). The ratio of PVA and the ion exchange resin powder is 1:1 by weight. The coated spacer using the heterogeneous conductive coating is referred to as PVA+IX coated PP spacer. The testing results using the PVA+IX coated PP spacer are shown in Table 1.

TABLE 1

| IEC (meq/g | Resistance reduction | Salt removal efficiency |
|---|---|---|
| polymeric | vs. uncoated | increase % vs. uncoated |
| coating) | plastic netting | plastic netting |
| 1.0 | 0 | 0 |

Seen from Table 1, performance of the PVA+IX coated PP spacer showed no improvement on resistance reduction and performance of the EDR stack with the PVA+IX coated PP spacer showed no improvement on stack's current density and salt removal rate, even though such the heterogeneous conductive coating has 1.0 meq/g (milliequivalent/gram) ion exchange capacity (IEC).

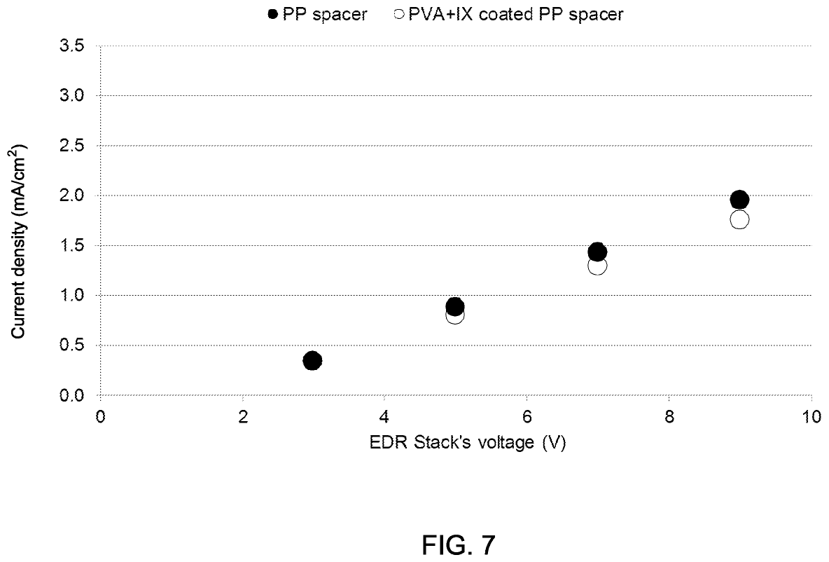

FIG. 7 demonstrates a comparison diagram of current density of the EDR stacks using the PVA+IX coated PP spacer and the PP spacer. It could be seen from FIG. 7 that the performance of the EDR stack using the PVA+IX coated PP spacer had no any increase on the current density relative to the EDR stack using the PP spacer.

### Embodiment 1

In some embodiments, the polymeric coating of the present disclosure may include a sulfonated block copolymer. The sulfonated block copolymer includes sulfonate groups in one block which content is high enough to form a continuous microphase through macroscopic scale.

Examples of such the sulfonated block copolymer may for example include, but not limited to, a sulfonated poly(styrene-b-ethylene-r-butylene-b-styrene) triblock copolymer (S-SEBS), polystyrene poly(styrene-b-isobutylene-b-styrene) (S-SIBS), poly((norbornenylethylstyrene-s-styrene)-b-(n-propyl-p-styrene sulfonate)) (PNS-PSSP), or poly(t-butylstyrene-b-hydrogenated isoprene-b-sulfonated styrene-b-hydrogenated isoprene-b-t-butylstyrene).

### EXAMPLE 1

### Sulfonated Pentablock Copolymer Coating

A sulfonated pentablock copolymer, poly(t-butylstyrene-b-hydrogenated isoprene-b-sulfonated styrene-b-hydrogenated isoprene-b-t-butylstyrene), provided by Kraton Polymers LLC, was dissolved in a solvent. The solvent used was a mixture of cyclohexane and heptane. Thus, a sulfonated pentablock copolymer solution was prepared, and then, the sulfonated pentablock copolymer solution was coated onto the PP netting. The coated spacer is referred to as the Kraton coated PP spacer.

Please reference to Journal of Membrane Science 2012, 169-174, 394-395, J. H. Choi, C. L. Willis and K. I. Winey investigated the self-assembled morphologies of such pentablock copolymer film. When the IEC was 2.0 meq/g polymer, sulfonated styrene mid-block formed bicontinuous and interconnnected microdomains, but when the IEC got lower, the microdomains became discrete. When such the pentablock copolymer is coated onto the PP netting, it could be observed that the resistance reduction behavior was highly dependent to the morphology of the polymer.

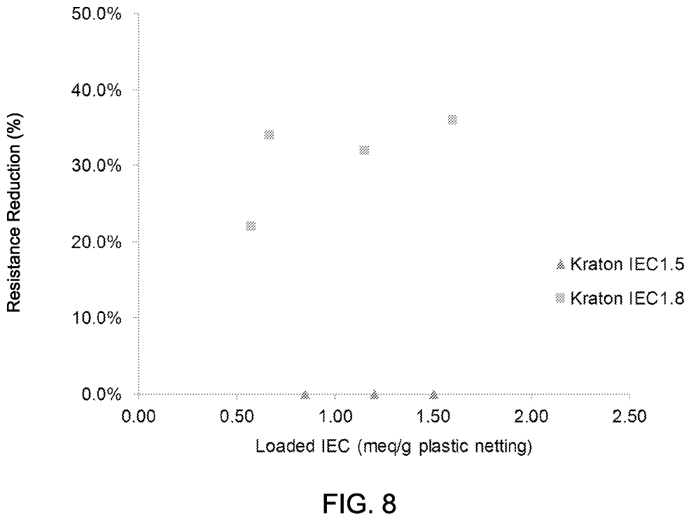

FIG. 8 illustrates a diagram of resistance reduction of Kraton coated PP spacers having different IECs. As shown in FIG. 8, there is no resistance reduction of the Kraton coated PP spacer at all when the IEC is 1.5 meq/g polymer, no matter how much the polymer coating is applied. The resistance reduction of the Kraton coated PP spacer jumped to 30-40% when the IEC increased to 2.0 meq/g. Thus, it indicated that the interconnected ionic microdomains is critical for resistance reduction of the spacer.

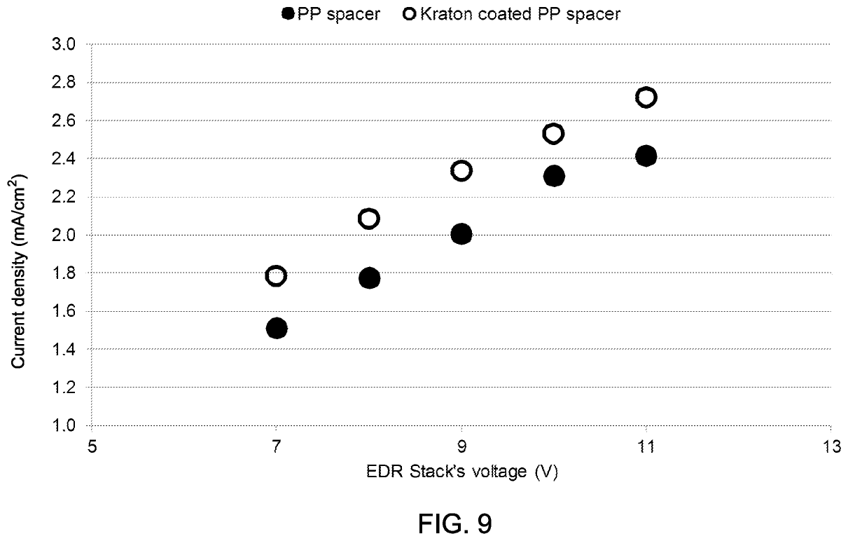

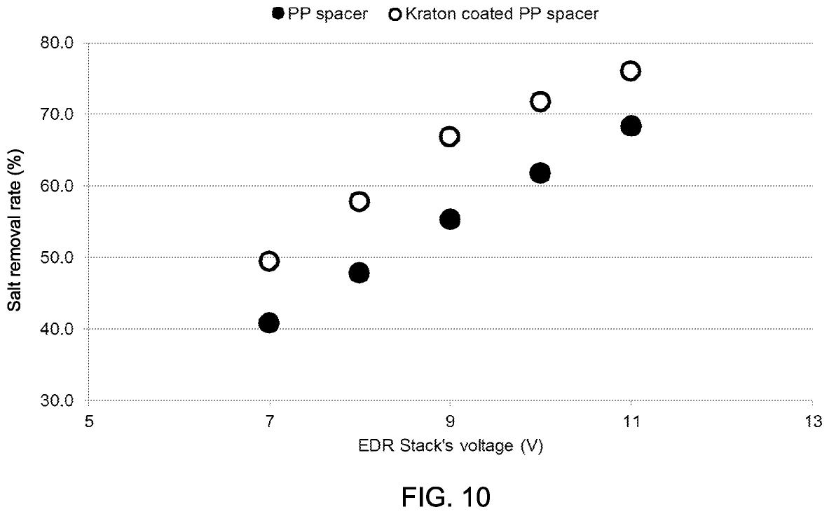

Referring to FIGS. 9 and 10, in the test of the EDR stack shown in FIGS. 9 and 10, the EDR stack had 10 cell pairs, and the feed stream used 0.01 mol/L NaCl solution.

FIG. 9 demonstrates a comparison diagram of current density of the EDR stacks using the Kraton coated PP spacer and the PP spacer. It could be seen from FIG. 9 that the performance of the EDR stack using the Kraton coated PP spacer had obvious increase on the current density relative to the EDR stack using the PP spacer.

FIG. 10 demonstrates a comparison diagram of salt removal rate of the EDR stacks using the Kraton coated PP spacer and the PP spacer. It could be seen from FIG. 10 that the EDR stack using the Kraton coated PP spacer improved the salt removal efficiency relative to the EDR stack using the PP spacer.

### Embodiment 2

In some embodiments, the polymeric coating of the present disclosure may include a perfluorinated polymer having sulfonate groups on side chains.

The perfluorinated polymer may for example include, but not limited to, a copolymer of tetrafluoroethylene and perfluoro (alkyl vinyl ether) with sulfonyl acid fluoride, or a sulfonated polymer of α,β,β-trifluorostyrene.

### EXAMPLE 2

### Sulfonated Perfluorinated Polymer Coating

Nafion (DuPond) is a copolymer of tetrafluoroethylene and perfluoro (alkyl vinyl ether) with sulfonyl acid fluoride. Nafion is the trademark for a class of closely related ionomers that consist of a poly(tetrafluoroethylene) backbone chain and regularly spaced short perfluorinated polyether side chains. The morphologies of perfluorinated ionomer membranes have been studied extensively. Gierke et al. suggested that the morphology of Nafion consists of ionic sulfonate clusters connected by ionic channels lined with sulfonate groups that permit the migration of protons or positive ions. (please reference to T. D. Gierke, G. E. Munn, F. C. Wilson, J. Polym. Sci., Polym. Phys., 1981, 19, 1687).

The PP netting was coated with Nafion solution (which was purchased from Sigma Aldrich) and followed by solvent removal under vacuum condition. The coated spacer is referred to as the Nafion coated PP spacer.

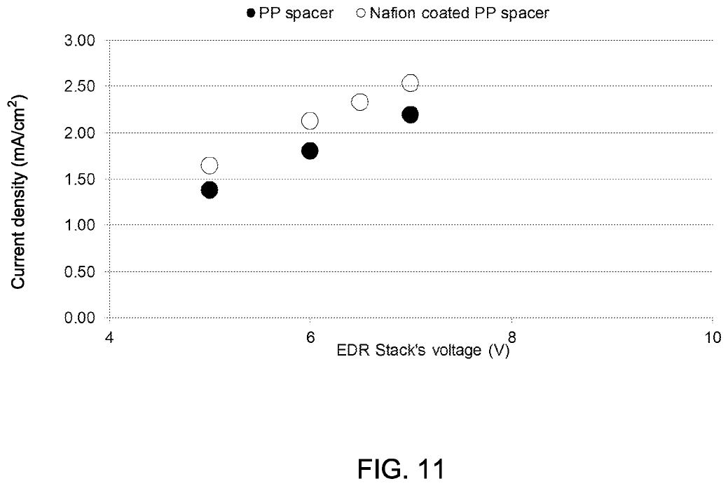

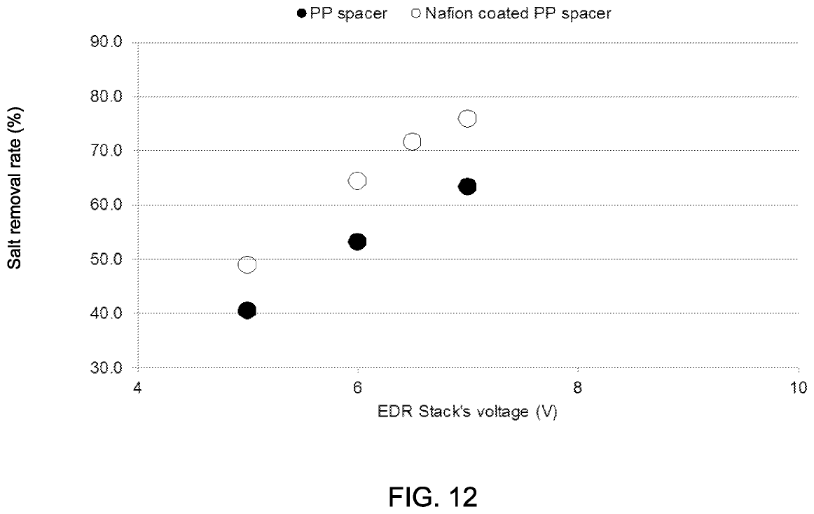

Referring to FIGS. 11 and 12, in the test of the EDR stack shown in FIGS. 11 and 12, the EDR stack had 5 cell pairs, and the feed stream used 0.01 mol/L Na₂SO₄ solution.

FIG. 11 demonstrates a comparison diagram of current density of the EDR stacks using the Nafion coated PP spacer and the PP spacer. It could be seen from FIG. 11 that the performance of the EDR stack using the Nafion coated PP spacer had obvious increase on the current density relative to the EDR stack using the PP spacer.

FIG. 12 demonstrates a comparison diagram of salt removal rate of the EDR stacks using the Nafion coated PP spacer and the PP spacer. It could be seen from FIG. 12 that the EDR stack using the Nafion coated PP spacer improved the salt removal efficiency relative to the EDR stack using the PP spacer.

### Embodiment 3

In some embodiments, the polymeric coating of the present disclosure may include a sulfonated aromatic polymer. The amount of sulfonate groups in the sulfonated aromatic polymer is in a range of 1.5-2.3 milli equivalent/gram.

The sulfonated aromatic polymer may include an aromatic polymer selected from the group consisting of sulfonated polystyrene, sulfonated polysulfone, sulfonated polyethersulfone, sulfonated polyphenylsulfone, sulfonated 2,6-dimethyl polyphenylene oxide, sulfonated polyetherketone, sulfonated polyetherether ketone, sulfonated polyimide, sulfonated polyphenylsulfide, sulfonated polybenzimidazole, sulfonated poly(arylene ether ether nitrile), sulfonated poly(arylene ether sulfone), sulfonated poly(arylene ether benzonitrile), a derivative thereof, and a combination thereof.

The sulfonated aromatic polymer can be synthesized from either direct sulfonation of the corresponding polymers using sulfuric acid or polymerization with sulfonated monomers in a desired ratio. Some of sulfonated aromatic polymers can also be commercially available. For instance, sulfonated polysulfone, and sulfonated polyetherether ketone can be purchased from Fumatech BWT GmbH.

### EXAMPLE 3

### Sulfonated Polysulfone Coating

Sulfonated polysulfone (SPSU) with different sulfonation degrees were purchased from Shanghai Chunyi Chemical Company. The ion exchange capacity (IEC) is equivalent to mmol-SO₃ H group per gram polymer sample, where sulfonation degree is described as mol % of sulfonated monomers of the whole monomer units. The sulfonation degree could be measured by NMR (Nuclear Magnetic Resonance) spectra. These two parameters, the IEC and the sulfonation degree, can be converted to each other as shown in Table 2.

TABLE 2

| | Sulfonation degree | IEC |
|---|---|---|
| Polymer sample | mol % —SO₃H | (meq/g polymer) |
| SPSU20 | 20% | 0.84 |
| SPSU40 | 40% | 1.57 |
| SPSU50 | 50% | 1.91 |
| SPSU60 | 60% | 2.22 |

Sulfonated polysulfone (SPSU) was dissolved in N,N-dimethylacetamide (DMAC) to prepare a SPSU solution. The PP netting was then coated with the SPSU solution and followed by solvent removal under vacuum condition. The coated spacer is referred to as the SPSU coated PP spacer.

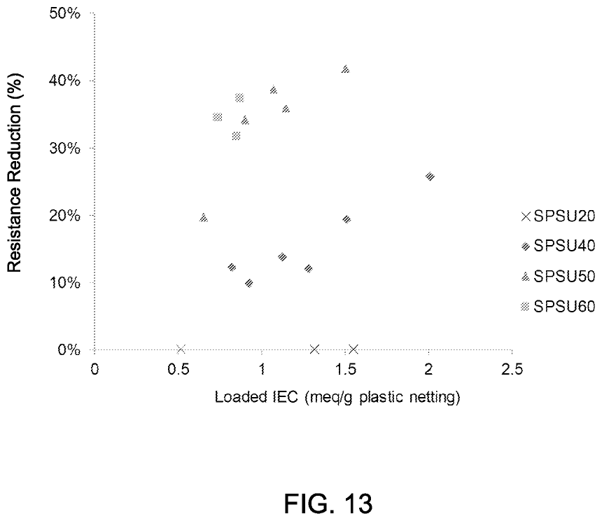

FIG. 13 demonstrates a diagram of resistance reduction of the SPSU coated PP spacers having different sulfonation degrees. It is clearly observed from FIG. 13 that when the sulfonation degree is under 40%, the sulfonated polysulfone coating is not able to reduce the resistance of the PP netting even though the loaded charge density is as high as 1.6 meq/g plastic netting. In contrast, when the sulfonation degree is 60%, the resistance reduction was already above 30% at only 0.7 meq/g plastic netting ion exchange capacity. Such significant impact of sulfonation degree to resistance reduction can be explained by percolation theory which has been applied in explaining the ionic conductivity of ion exchange membrane. (please reference to Xu, T. W. et al./Chemical Engineering Science 2001, 56, 5343-5350). At low ion exchange capacities, i.e., low ionic group concentrations (e.g. 20 mol % sulfonation), ion clusters are well separated into “islands”, and thus macroscopic ion flow is impossible. At a higher ion exchange capacity, these “islands” grow in size and interconnect to form extended pathways. When above a threshold value, conductive channels form and the average size of the extended pathways become macroscopic (e.g. 40 mol % sulfonation). At even higher ion exchange capacities, percolation channels fill the missing links, resulting in progressively higher conductivity (e.g. 60 mol % sulfonation).

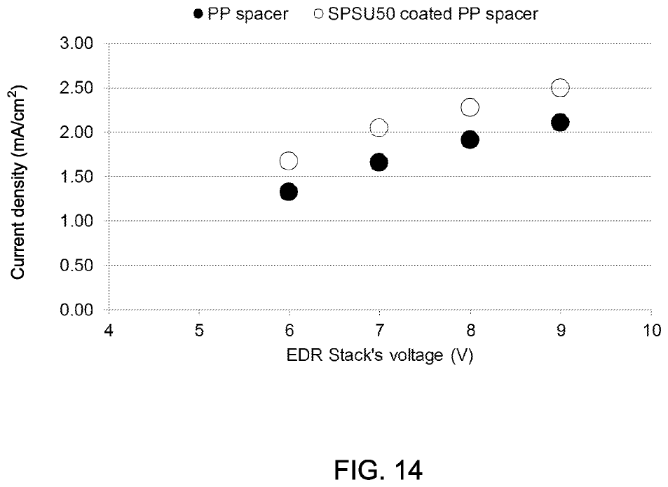

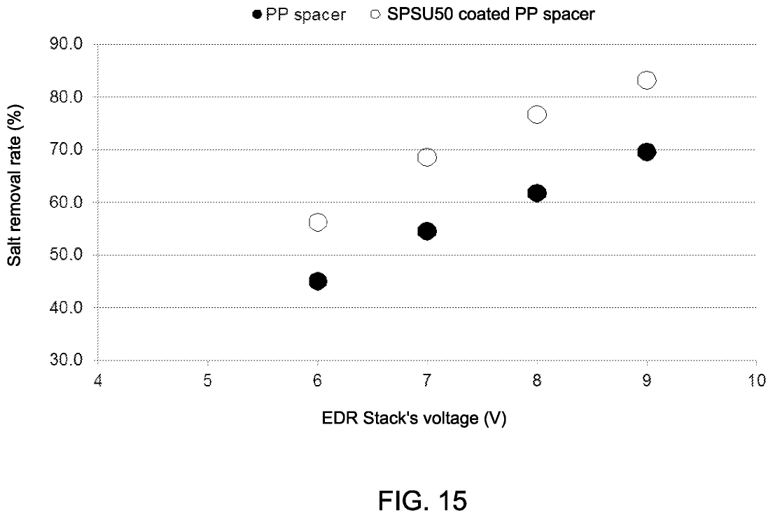

Referring to FIGS. 14 and 15, in the test of the EDR stack shown in FIGS. 14 and 15, the EDR stack had 10 cell pairs, the EDR stack used SPSU50 coating, and the feed stream used 0.01 mol/L NaCl solution.

FIG. 14 demonstrates a comparison diagram of current density of the EDR stacks using the SPSU50 coated PP spacer and the PP spacer. It could be seen from FIG. 14 that the performance of the EDR stack using the SPSU50 coated PP spacer had obvious increase on the current density relative to the EDR stack using the PP spacer.

FIG. 15 demonstrates a comparison diagram of salt removal rate of the EDR stacks using SPSU50 coated PP spacer and PP spacer. It could be seen from FIG. 15 that the EDR stack using the SPSU50 coated PP spacer improved the salt removal efficiency relative to the EDR stack using the PP spacer.

Based on all the above examples, it can be concluded that in order to achieve conductivity increase and resistance reduction of the PP netting and corresponding salt removal efficiency increase, conductive polymer coating needs to form macroscopic and continuous ion exchange channels. That is, the morphology of the polymeric coating needs to have interconnected ionic clusters.

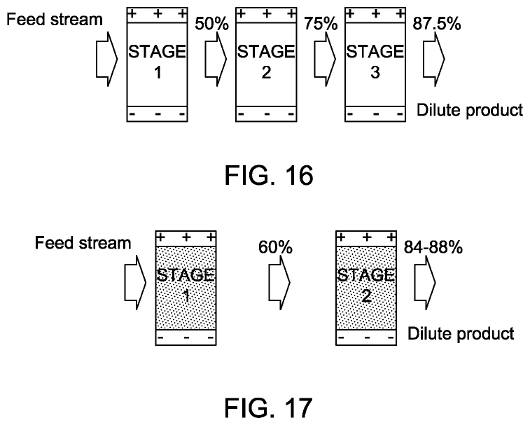

FIG. 16 illustrates a schematic diagram of desalination efficiency of an EDR three stages system without conductive spacer, and FIG. 17 illustrates a schematic diagram of desalination efficiency of an EDR two stages system with ion conductive spacer in accordance with an embodiment of the present disclosure. It can be seen clearly from FIGS. 16 and 17, for the EDR system without conductive spacer, the salt removal rate of stage 1 is only 50% and the salt removal rate of stage 2 is 75%. After stage 3, the salt removal rate of the EDR system reaches 87.5%. However, for the EDR system with the ion conductive spacer of the present disclosure, the salt removal rate of stage 1 reaches 60%, and after stage 2, the salt removal rate of the EDR system reaches 84-88%. In comparison to the EDR system without conductive spacer, the EDR system with the ion conductive spacer of the present disclosure may improve salt removal efficiency greatly and reduce product costs.

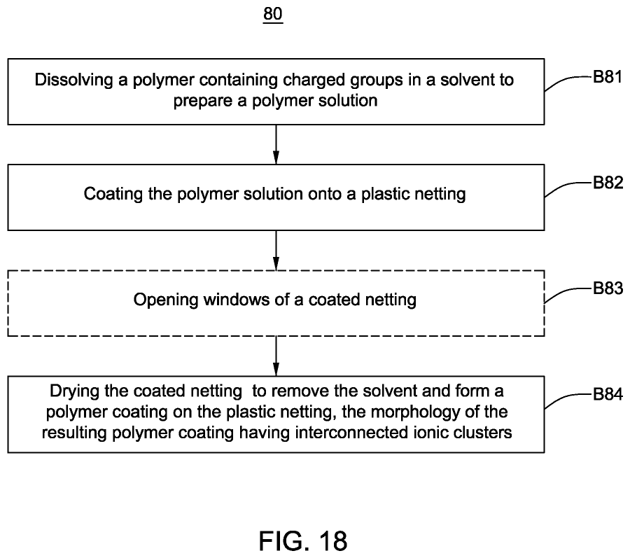

In one embodiment, the present disclosure may further provide a process 80 for preparing an ion conductive spacer in an electrodialysis reversal stack. FIG. 18 illustrates a flow chart of an exemplary process 80 for preparing an ion conductive spacer in an electrodialysis reversal stack in accordance with a first embodiment of the present disclosure.

As shown in FIG. 18, in block B81, a polymer containing charged groups may be dissolved in a solvent to prepare a polymer solution. The solvent may for example include, N,N-dimethylformamide (DMF), N,N-dimethylacetamide (DMAC), dimethyl sulfoxide (DMSO), N-methyl-2-pyrrolidone (NMP), heptane, cyclohexane, tetrahydrafuran, acetone, isopropanol, methanol, methylenechloride and so on.

In block B82, the polymer solution may be coated onto a plastic netting 201 (as shown in FIGS. 2 and 3) to form a coated netting as shown in FIGS. 4-5. Coating the polymer solution can be applied by for example, dip-coating, brush-coating, roller-coating, or spray-coating.

In an optional embodiment, the process 80 of the present disclosure may further include an optional block B83 after block B82 and before block B84. In the optional block B83, windows 203 of the coated netting may be opened by air force or absorption.

Typically, the air force is air flow generated by an air blower or an air knife. The absorption can be realized through sponge roller or brush roller. With proper design and control of operation conditions, for example, control of air flow angle and air force, the waste of coating material can be minimized.

In block B84, the coated netting may be dried. Thus, the solvent may be removed and a polymer coating is formed on the plastic netting. The morphology of the resulting polymer coating has interconnected ionic clusters which allow continuous and macroscopic ion transportation throughout a surface of the plastic netting. The coated netting may be dried by hot air, vacuum or microwave so as to remove the solvent.

The ion conductive spacer prepared by such the process may have better ionic conductivity and lower resistance. Using such the ion conductive spacer of the present disclosure may help to improve salt removal efficiency in the electrodialysis reversal application.

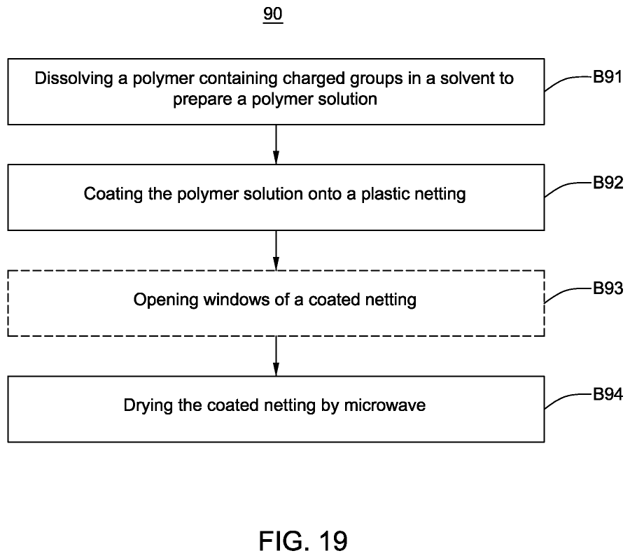

In another embodiment, the present disclosure may further provide a process 90 for preparing an ion conductive spacer. FIG. 19 illustrates a flow chart of an exemplary process 90 for preparing an ion conductive spacer in accordance with a second embodiment of the present disclosure.

As shown in FIG. 19, in block B91, a polymer containing charged groups may be dissolved in a solvent, to prepare a polymer solution.

In block B92, the polymer solution may be coated onto a plastic netting 201 (as shown in FIGS. 2 and 3) to form a coated netting by for example, dip-coating, brush-coating, roller-coating, or spray-coating.

In an optional embodiment, the process 90 of the present disclosure may further include an optional block B93 after block B92 and before block B94. In the optional block B93, windows of the coated netting may be opened by air force or absorption.

In block B94, the coated netting may be dried by microwave so as to remove the solvent.

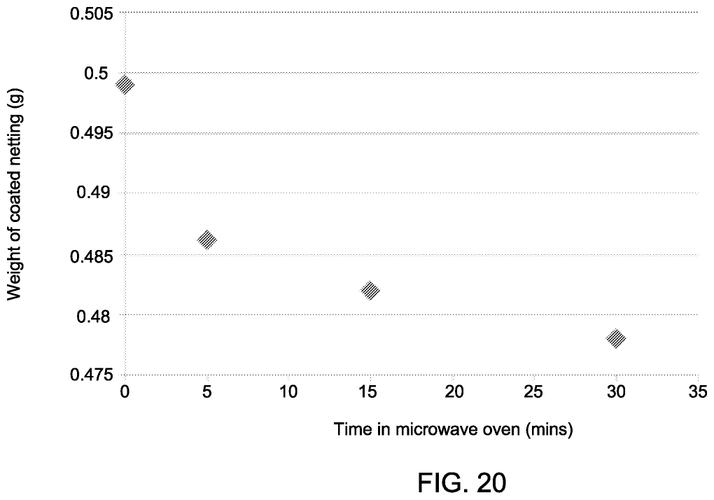

With reference to FIG. 20, when the coated netting is put into a microwave oven, the weight of coated plastic netting will decrease over time, which may prove that the solvent is removed gradually and thus prove that microwave may be used for solvent removal.

Because the plastic netting 201 is non-polar and the non-polar plastic netting 201 doesn't absorb microwave, while the solvent is polar and the polar solvent absorb microwave, microwave may selectively heat the solvent. The non-polar plastic netting 201 will not be heated. Therefore, the plastic netting 201 has no deformation risk.

As an example, when drying by using microwave, dimensional change of the plastic netting 201 is 0%; while heating in 100° C. oven, dimensional change of the plastic netting 201 is 5%. The higher the temperature of heating, the more serious the deformation of the plastic netting 201. Furthermore, the longer the time of heating, the more serious the deformation of the plastic netting 201.

Thus, it can be seen that drying by microwave cannot cause deformation of the plastic netting 201, while drying by hot air will cause the plastic netting 201 to deform. The above test is performed under only 700 W microwave power due to limitation of testing circumstance. Although evaporation rate of drying under only 700 W microwave power is a half of using hot air, much higher microwave power may be used in the practical industry and expected higher evaporation rate will be thus obtained with industrial microwave power, for example 100 KW.

Microwave is applied to the drying process, which can effectively prevent the plastic netting 201 from deformation, can assure coated spacer's quality and can greatly reduce product cost.

The above processes 80 and 90 given herein are non-exhaustive and must not be construed as limiting the invention disclosed in this specification. The processes 80 and 90 for preparing the ion conductive spacer according to the first embodiment and the second embodiment above can be combined together to use.

While steps of the processes for preparing the ion conductive spacer in accordance with embodiments of the present disclosure are illustrated as functional blocks, the order of the blocks and the separation of the steps among the various blocks shown in FIGS. 18-19 are not intended to be limiting. For example, the blocks may be performed in a different order and a step associated with one block may be combined with one or more other blocks or may be sub-divided into a number of blocks.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. An ion conductive spacer for use in an electrodialysis reversal stack comprising:
a plastic netting; and
a polymeric coating coated on the plastic netting and containing charged groups, wherein the morphology of the polymeric coating has interconnected ionic clusters which allow continuous and macroscopic ion transportation throughout a surface of the plastic netting.

2. The ion conductive spacer of claim 1, wherein the polymeric coating comprises a sulfonated block copolymer.

3. The ion conductive spacer of claim 2, wherein the sulfonated block copolymer comprises a sulfonated poly(styrene-b-ethylene-r-butylene-b-styrene) triblock copolymer, polystyrene poly(styrene-b-isobutylene-b-styrene), poly((norbornenylethylstyrene-s-styrene)-b-(n-propyl-p-styrenesulfonate)), or poly(t-butylstyrene-b-hydrogenated isoprene-b-sulfonated styrene-b-hydrogenated isoprene-b-t-butyl styrene).

4. The ion conductive spacer of claim 1, wherein the polymeric coating comprises a perfluorinated polymer having sulfonate groups on side chains.

5. The ion conductive spacer of claim 4, wherein the perfluorinated polymer comprises a copolymer of tetrafluoroethylene and perfluoro (alkyl vinyl ether) with sulfonyl acid fluoride, or a sulfonated polymer of α,β,β-trifluorostyrene.

6. The ion conductive spacer of claim 1, wherein the polymeric coating comprises a sulfonated aromatic polymer.

7. The ion conductive spacer of claim 6, wherein the amount of sulfonate groups in the sulfonated aromatic polymer is in a range of 1.5-2.3 milli equivalent/gram.

8. The ion conductive spacer of claim 6, wherein the sulfonated aromatic polymer comprises an aromatic polymer selected from the group consisting of sulfonated polystyrene, sulfonated polysulfone, sulfonated polyethersulfone, sulfonated polyphenylsulfone, sulfonated 2,6-dimethyl polyphenylene oxide, sulfonated polyetherketone, sulfonated polyetherether ketone, sulfonated polyimide, sulfonated polyphenylsulfide, sulfonated polybenzimidazole, sulfonated poly(arylene ether ether nitrile), sulfonated poly(arylene ether sulfone), sulfonated poly(arylene ether benzonitrile), a derivative thereof, and a combination thereof.

9. An electrodialysis reversal stack comprising:
a first electrode and a second electrode;
a plurality of ion conductive spacers as claimed in any one of claims 1-8 and located between the first and the second electrodes; and
at least one anionic exchange membrane and at least one cationic exchange membrane which are inserted alternately between every adjacent two ion conductive spacers.

10. A process for preparing an ion conductive spacer in an electrodialysis reversal stack, comprising:
dissolving a polymer containing charged groups in a solvent to prepare a polymer solution;
coating the polymer solution onto a plastic netting to form a coated netting; and
drying the coated netting so as to remove the solvent and form a polymer coating on the plastic netting, wherein the morphology of the resulting polymer coating has interconnected ionic clusters which allow continuous and macroscopic ion transportation throughout a surface of the plastic netting.

11. The process of claim 10, wherein coating the polymer solution onto the plastic netting comprises: coating the polymer solution by dip-coating, brush-coating, roller-coating, or spray-coating, onto the plastic netting.

12. The process of claim 10, further comprising:
opening windows of the coated netting.

13. The process of claim 10, wherein drying the coated netting comprises: drying the coated netting by microwave so as to remove the solvent.

14. A process for preparing an ion conductive spacer, comprising:
dissolving a polymer containing charged groups in a solvent to prepare a polymer solution;
coating the polymer solution onto a plastic netting to form a coated netting; and
drying the coated netting by microwave so as to remove the solvent.

15. The process of claim 14, further comprising:
opening windows of the coated netting.
